(19) United States
(12) Patent Application Publication
(10) Pub. No.: US 2014/0235241 A1
(43) Pub. Date: Aug. 21, 2014

(54) EPLMN TRANSITION MECHANISM FOR MANUAL NETWORK REGISTRATION

(71) Applicant: Marvell World Trade Ltd., St. Michael (BB)

(72) Inventors: Eytam Sharan, Reut (IL); Shaham Kenat, Nes Ziona (IL)

(73) Assignee: Marvell World Trade Ltd., St. Michael (BB)

(21) Appl. No.: 14/184,783

(22) Filed: Feb. 20, 2014

Related U.S. Application Data
(60) Provisional application No. 61/767,527, filed on Feb. 21, 2013.

(51) Int. Cl. H04W 60/04

(52) U.S. Cl. CPC H04W 60/04
USPC 455/435.2

(57) ABSTRACT

A method includes, in a mobile communication terminal configured to operate in a manual network registration mode, maintaining in a memory a list of one or more Equivalent Public Land Mobile Networks (EPLMNs) with which the terminal is permitted to register. Upon registering with a Public Land Mobile Network (PLMN), the one or more EPLMNs already on the list are retained, and, if receiving from the PLMN a notification of at least one EPLMN defined for the PLMN, the at least one EPLMN is added to the list. In response to loss of communication with the PLMN, registration is performed with a selected EPLMN among the EPLMNs appearing on the list.

### CROSS-REFERENCE TO RELATED APPLICATIONS

This application claims the benefit of U.S. Provisional Patent Application 61/767,527, filed Feb. 21, 2013, whose disclosure is incorporated herein by reference.

### FIELD OF THE DISCLOSURE

The present disclosure relates generally to wireless communication, and particularly to methods and systems for Equivalent Public Land Mobile Network (EPLMN) management.

### BACKGROUND

Cellular phones and other mobile communication terminals are typically configured to register with and communicate via various Public Land Mobile Networks (PLMNs). The Third Generation Partnership Project (3GPP), for example, specifies PLMN selection processes in “Technical Specification Group Core Network and Terminals; Non-Access-Stratum (NAS) functions related to Mobile Station (MS) in idle mode (Release 12),” TS 23.122, version 12.3.0, December, 2013, which is incorporated herein by reference. Section 4.4 of this document specifies PLMN selection processes, including automatic and manual PLMN selection modes.

Procedures relating to PLMN selection are also specified in 3GPP Technical Specification 24.008, entitled “Technical Specification Group Core Network and Terminals; Mobile radio interface Layer 3 specification; Core network protocols; Stage 3 (Release 12),” TS 24.008, version 12.4.0, December, 2013, which is incorporated herein by reference. Chapter 4 of this specification, for example, specifies Mobility Management (MM) procedures, including PLMN selection.

The 3GPP documents cited above specify the use of a list of Equivalent PLMNs (EPLMNs), which are regarded as equivalent to each other for purposes of PLMN selection, cell selection/re-selection and handover.

The description above is presented as a general overview of related art in this field and should not be construed as an admission that any of the information it contains constitutes prior art against the present patent application.

### SUMMARY

An embodiment that is described herein provides a method including, in a mobile communication terminal configured to operate in a manual network registration mode, maintaining in a memory a list of one or more Equivalent Public Land Mobile Networks (EPLMNs) with which the terminal is permitted to register. Upon registering with a Public Land Mobile Network (PLMN), the one or more EPLMNs already on the list are retained, and, if receiving from the PLMN a notification of at least one EPLMN defined for the PLMN, the at least one EPLMN is added to the list. In response to loss of communication with the PLMN, registration is performed with a selected EPLMN among the EPLMNs appearing on the list.

In some embodiments, retaining the EPLMNs includes permitting the terminal, which operates in the manual network registration mode, to automatically join any of the PLMNs with which the terminal previously registered since the most-recent manual registration operation. In an embodiment, maintaining the list includes resetting the list in response to a new manual network registration attempt. In another embodiment, maintaining the list includes resetting the list in response to a transition to an automatic network registration mode.

In yet another embodiment, the method includes retaining a definition of the PLMN as a manually registered PLMN, regardless of transitioning to any of the EPLMNs appearing on the list. In a disclosed embodiment, maintaining the list includes omitting from the list one or more PLMNs that are defined as forbidden. In an embodiment, maintaining the list includes storing the list so as to be directly accessible to a Radio Resource Control (RRC) layer of the terminal, and registering with the selected EPLMN includes reselecting a cell of the selected EPLMN using the RRC layer, by directly accessing the list using the RRC layer without involvement of a higher layer.

There is additionally provided, in accordance with an embodiment that is described herein, apparatus including a memory and processing circuitry. The processing circuitry is configured, when operating in a manual network registration mode, to store in the memory a list of one or more Equivalent Public Land Mobile Networks (EPLMNs) with which the apparatus is permitted to register, to retain the one or more EPLMNs already on the list upon registering with a Public Land Mobile Network (PLMN), and, if receiving from the PLMN a notification of at least one EPLMN defined for the PLMN, to add the at least one EPLMN to the list, and, in response to loss of communication with the PLMN, to register with a selected EPLMN among the EPLMNs appearing on the list.

In some embodiments, a mobile communication terminal includes the disclosed apparatus. In some embodiments, a chipset for processing signals in a mobile communication terminal includes the disclosed apparatus.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a cellular communication system, in accordance with an embodiment that is described herein;

FIG. 2 is a flow chart that schematically illustrates a method for manual registration with a PLMN, in accordance with an embodiment that is described herein; and

FIG. 3 is a flow chart that schematically illustrates a process of transitioning to an EPLMN in manual registration mode, in accordance with an embodiment that is described herein.

### DETAILED DESCRIPTION OF EMBODIMENTS

According to the 3GPP specifications cited above, when a terminal registers with a PLMN, the registered PLMN optionally downloads to the terminal a list of Equivalent PLMNs (EPLMNs) that the terminal is permitted to switch to in case of communication loss (i.e., loss of connectivity, or inability to communicate with the current PLMN). According to section 4.1.1.9 of 3GPP TS 24.008, the list stored by the terminal consists of equivalent PLMNs as downloaded by the network, plus the PLMN code of the registered PLMN that downloaded the list.

When operating in manual registration mode (also referred to as manual PLMN selection mode), the terminal is permitted to switch automatically only to PLMNs appearing on the EPLMN list in case of communication loss with the registered PLMN. In various practical scenarios occurring in manual registration mode, however, the EPLMN mechanism does not perform well and may lead to loss of service.

Consider, for example, a scenario in which PLMN_A defined PLMN_B as an EPLMN, but PLMN_B did not define any EPLMNs. A terminal that is registered with PLMN_A in manual registration mode will have the option of switching automatically to PLMN_B if communication with PLMN_A is lost. Once registered with PLMN_B, however, the terminal has no EPLMNs to switch to because PLMN_B did not define any EPLMNs. Loss of communication with PLMN_B will cause the terminal to lose service altogether and revert to the user for manual PLMN selection. Various other scenarios lead to the same end result.

Embodiments that are described herein provide improved methods and systems for Equivalent EPLMN management in mobile communication terminals. In the disclosed embodiments, when registering with a PLMN in manual registration mode, the terminal retains its existing list of EPLMNs, and adds to the list any PLMNs that are indicated as equivalent by the registered PLMN. The identities of previously-listed EPLMNs are not lost but rather accumulate as the terminal transitions from one PLMN to another. In some embodiments, the terminal resets the list of EPLMNs when the user re-initiates manual network selection or switches to automatic registration mode.

The disclosed techniques enable a terminal that operates in manual registration mode to automatically switch to any of the PLMNs that were visited since the most-recent manual registration. As a result, the probability of loss of service is reduced considerably, service can be regained with minimal delay, and user experience is enhanced.

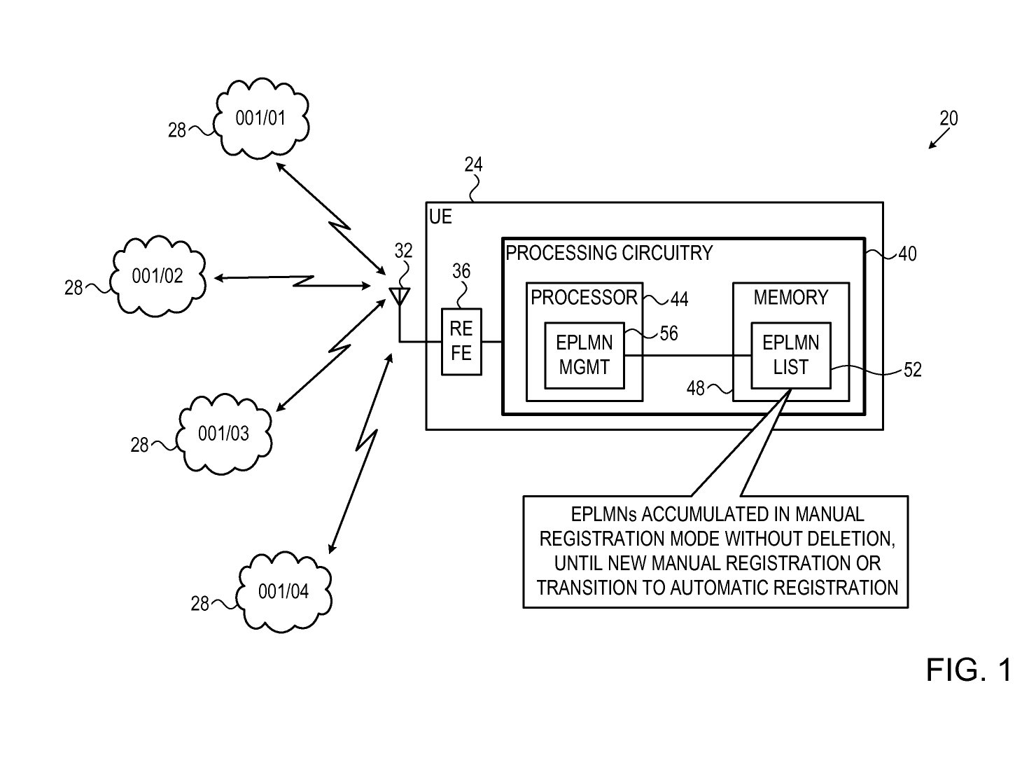

FIG. 1 is a block diagram that schematically illustrates a cellular communication system 20, in accordance with an embodiment that is described herein. System 20 comprises a mobile communication terminal 24, which is configured to register with and communicate via various PLMNs 28. Terminal 24 comprises, for example, a cellular phone, a smartphone, a mobile or tablet computer, a cellular access point, an automotive cellular modem, a Machine-to-Machine (M2M) terminal, a USB dongle, or any other suitable type of communication terminal. In the description that follows, terminal 24 is sometimes referred to as User Equipment (UE) or Mobile Station (MS).

The present example shows four PLMNs denoted 001/01, 001/02, 001/03 and 001/04, although any other suitable number of PLMNs can be used. Terminal 24 and PLMNs 28 may operate in accordance with any suitable Radio Access Technology (RAT), both currently-standardized and future-contemplated, such as, for example, Global System for Mobile Communications (GSM), Universal Mobile Telecommunications System (UMTS), Long-Term Evolution (LTE) or LTE-Advanced (LTE-A). PLMN selection processes are generally regarded as Non-Access-Stratum (NAS) functions, and as such are RAT-independent.

In the embodiment of FIG. 1, terminal 24 comprises at least one antenna 32, a Radio-Frequency Front End (RF FE) 36 and processing circuitry 40. RF FE 36 performs the various RF and analog transmission and reception functions of the terminal, whereas processing circuitry 40 performs the various digital and baseband functions.

Among other tasks, processing circuitry 40 carries out various PLMN selection processes that are described below. In the present example, processing circuitry 40 comprises a processor 44 and a memory 48. Processor 44 comprises an EPLMN management module 56, which maintains and manages an EPLMN list 52 stored in memory 48. As will be explained in detail below, when terminal 24 operates in manual registration mode, EPLMN list 52 accumulates the EPLMNs of the various PLMNs visited by the terminal since the most recent manual registration attempt.

The configuration of terminal 24 shown in FIG. 1 is a highly simplified example configuration, which is depicted solely for the sake of clarity. In alternative embodiments, any other suitable terminal configuration can be used. Some terminal elements that are not mandatory for understanding of the disclosed techniques have been omitted from the figures for the sake of clarity. The different elements of terminal 24 are typically implemented using dedicated hardware, such as using one or more Application-Specific Integrated Circuits (ASICs), Radio frequency Integrated Circuits (RFIC) and/or Field-Programmable Gate Arrays (FPGAs). Alternatively, some terminal elements, e.g., processor 44, may be implemented using software executing on programmable hardware, or using a combination of hardware and software elements.

When implementing the disclosed techniques in software on a programmable processor, the software may be downloaded to the processor in electronic form, over a network, for example, or it may, alternatively or additionally, be provided and/or stored on non-transitory tangible media, such as magnetic, optical or electronic memory. In some embodiments, some elements of terminal 20 may be fabricated in a chip-set.

In some embodiments, terminal 24 supports two PLMN selection modes, referred to as automatic registration (or automatic PLMN selection) and manual registration (or manual PLMN selection). In the automatic registration mode, if the terminal loses communication with the registered PLMN (the PLMN with which it is currently registered), the terminal is permitted to register with any PLMN it is able to find. In the manual registration mode, if the terminal loses communication with the registered PLMN, the terminal is permitted to register automatically (i.e., without user intervention) only with PLMNs that appear on EPLMN list 52. If list 52 is empty, the terminal reverts to the user for manual PLMN selection.

When registering with a PLMN, the newly-joined PLMN downloads to the terminal a list of one or more PLMNs that are defined as EPLMNs (if any are defined). From the point of view of the newly-joined PLMN, this list specifies the PLMNs that the terminal is permitted to join automatically in case of communication loss in manual registration mode.

One possible strategy for managing EPLMN list 52 in manual registration mode is to delete list 52 on each transition to a different PLMN, and replace it with the (possibly empty) list that is downloaded from the newly-joined PLMN. This naïve solution, however, may not always perform well and in many scenarios may lead to loss of service.

Consider, for example, the four PLMNs shown in FIG. 1. In this example, terminal 24 operates in manual registration mode, and is initially registered with PLMN 001/01. PLMN 001/01 has PLMNs 001/02 and 001/03 defined as EPLMNs. At a certain point in time, terminal 24 loses communication with PLMN 001/01 but is able to find and register automatically with PLMN 001/02 (which is permitted since 001/02 is defined as an EPLMN of 001/01). On joining PLMN 001/02, PLMN 001/02 notifies terminal 24 that PLMN 001/04 is defined as an EPLMN. At some later time, terminal 24 loses communication with PLMN 001/02, in an area that is covered by PLMN 001/03 but not by PLMN 001/04.

If the terminal were to use the naïve solution of resetting EPLMN list 52 on each PLMN transition, the terminal would encounter an Out-of-Service (OOS) at this point, because PLMN 001/03 is not defined as an EPLMN of PLMN 001/02 (the currently-registered PLMN), even though PLMN 001/03 is an EPLMN of PLMN 001/01 (an earlier PLMN with which the terminal was registered). In other words, in the above naïve solution, the terminal is only able to switch to PLMNs that have been defined as EPLMNs by its current serving PLMN.

In the disclosed embodiments, on the other hand, EPLMN management module 56 does not reset EPLMN list 52 on every PLMN transition. Instead, module retains the EPLMNs that already appear on the list, and adds to them any EPLMN that is notified by the newly-joined PLMN. In this manner, EPLMN list 52 accumulates more EPLMNs as terminal 24 moves from one PLMN to another, allowing more EPLMN choices for the terminal to join in case of communication loss. Each additional EPLMN on list 52 relates back to the initial manually-registered PLMN via a thread of EPLMN definitions, but the list may well contain PLMNs that are not directly defined as EPLMNs of the manually-registered PLMN. Thus, after a series of transitions from one PLMN to another, the disclosed technique enables terminal 24 to switch back to any of the PLMNs it was previously registered with, regardless of the EPLMN definitions of the various PLMNs.

In the above scenario, for example, after losing communication with PLMN 001/02, the terminal is able to register automatically with PLMN 001/03 (which in the disclosed embodiments is retained on the EPLMN list from the time the terminal registered with PLMN 001/01). As a result, terminal 24 is able to rapidly resume service in manual mode, without involving the user.

In some embodiments, EPLMN management module 56 resets EPLMN list 52 in response to a new manual registration attempt by the user, and/or upon transition from manual registration mode to automatic registration mode. Thus, EPLMN list 52 accumulates the EPLMNs reported by the various PLMNs that terminal 24 registered with since the most-recent manual registration operation.

In some embodiments, EPLMN list 52 is also stored in (or at least directly accessible by) the Radio Resource Control (RRC) protocol layer of terminal 24. By accessing list 52 directly (i.e., without having to involve a higher layer), the RRC layer is able to perform rapid automatic reselection of cells of the various EPLMNs on the list, without a need for interaction with upper layers.

Typically, EPLMN management module 56 does not change the definition of the manually-selected PLMN, regardless of any transitions to EPLMNs that are carried out since the manual registration. In other words, after the user requests manual registration with a selected PLMN, the identity of this manually-selected PLMN will be retained even if the terminal moves once or more to EPLMNs using the disclosed techniques.

In some embodiments, EPLMN management module 56 erases or omits from list 52 any PLMNs that are defined as Forbidden PLMNs (FPLMNs). Module 56 is aware of the identities of FPLMNs, for example, from settings in the terminal's Subscriber Identity Module (SIM), or as a result of registration attempts with FPLMNs that resulted in rejection by the network. In an embodiment, module 56 checks and omits FPLMNs from list 56 whenever the list is updated.

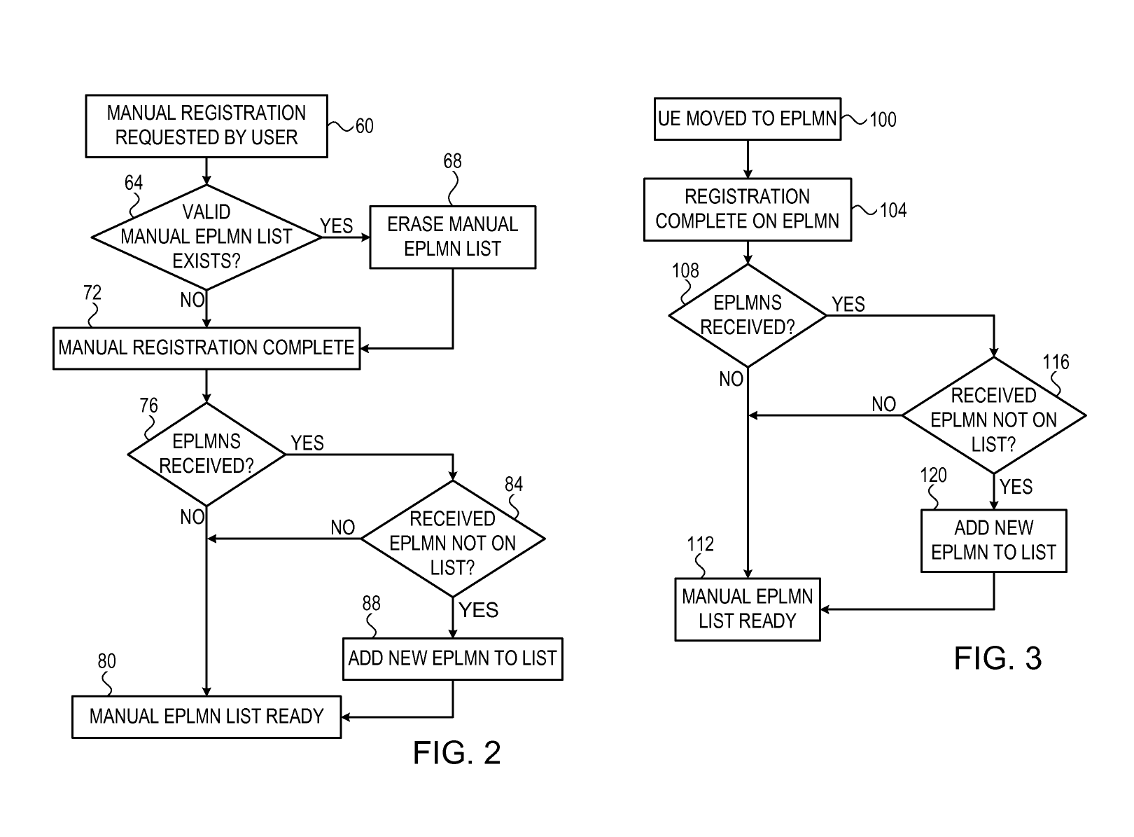

FIG. 2 is a flow chart that schematically illustrates a method for manual registration, in accordance with an embodiment that is described herein. The method begins with the user of terminal 24 initiating manual registration with a selected PLMN, at a manual requesting operation 60. EPLMN management module 56 checks whether EPLMN list 52 contains any valid entries, at a list checking operation 64. If so, module 56 erases EPLMN list 52, at a list resetting operation 68. Terminal completes the manual registration process with the selected PLMN, at a registration operation 72.

Module 56 checks whether the newly-joined PLMN notified terminal 24 of any EPLMNs, at a report checking operation 76. If not, EPLMN list 52 is regarded as ready and terminal 24 begins to communicate over the PLMN, at a communication operation 80.

If the newly-joined PLMN did notify terminal 24 of one or more EPLMNs, module 56 checks whether any of these EPLMNs do not already appear on list 52, at a new EPLMN checking operation 84. If so, module 56 adds the new EPLMN or EPLMNs to EPLMN list 52, at an EPLMN accumulation operation 88. Terminal 24 then proceeds to communicate over the newly-joined PLMN at communication operation 80.

FIG. 3 is a flow chart that schematically illustrates a process of transitioning to an EPLMN in manual registration mode, in accordance with an embodiment that is described herein. The method begins when terminal 24 moves to an EPLMN, at an EPLMN transition operation 100, e.g., following loss of communication with the registered PLMN. After registration with the newly-joined EPLMN completes, at a registration completion operation 104, EPLMN management module 56 checks whether the newly-joined EPLMN notified terminal 24 of any EPLMNs, at a report checking operation 108. If not, EPLMN list 52 is regarded as ready and terminal 24 begins to communicate over the EPLMN, at a communication operation 112.

If the newly-joined EPLMN did notify terminal 24 of one or more EPLMNs, module 56 checks whether any of these EPLMNs do not already appear on list 52, at a new EPLMN checking operation 116. If so, module 56 adds the new EPLMN or EPLMNs to EPLMN list 52, at an EPLMN accumulation operation 120. Terminal 24 then proceeds to communicate over the newly-joined EPLMN at communication operation 112.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a mobile communication terminal configured to operate in a manual network registration mode, maintaining in a memory a list of one or more Equivalent Public Land Mobile Networks (EPLMNs) with which the terminal is permitted to register;
upon registering with a Public Land Mobile Network (PLMN), retaining the one or more EPLMNs already on the list, and, if receiving from the PLMN a notification of at least one EPLMN defined for the PLMN, adding the at least one EPLMN to the list; and
in response to loss of communication with the PLMN, registering with a selected EPLMN among the EPLMNs appearing on the list.

2. The method according to claim 1, wherein retaining the EPLMNs comprises permitting the terminal, which operates in the manual network registration mode, to automatically join any of the PLMNs with which the terminal previously registered since the most-recent manual registration operation.

3. The method according to claim 1, wherein maintaining the list comprises resetting the list in response to a new manual network registration attempt.

4. The method according to claim 1, wherein maintaining the list comprises resetting the list in response to a transition to an automatic network registration mode.

5. The method according to claim 1, comprising retaining a definition of the PLMN as a manually registered PLMN, regardless of transitioning to any of the EPLMNs appearing on the list.

6. The method according to claim 1, wherein maintaining the list comprises omitting from the list one or more PLMNs that are defined as forbidden.

7. The method according to claim 1, wherein maintaining the list comprises storing the list so as to be directly accessible to a Radio Resource Control (RRC) layer of the terminal, and wherein registering with the selected EPLMN comprises reselecting a cell of the selected EPLMN using the RRC layer, by directly accessing the list using the RRC layer without involvement of a higher layer.

8. Apparatus, comprising:
a memory; and
processing circuitry, which is configured, when operating in a manual network registration mode, to store in the memory a list of one or more Equivalent Public Land Mobile Networks (EPLMNs) with which the apparatus is permitted to register, to retain the one or more EPLMNs already on the list upon registering with a Public Land Mobile Network (PLMN), and, if receiving from the PLMN a notification of at least one EPLMN defined for the PLMN, to add the at least one EPLMN to the list, and, in response to loss of communication with the PLMN, to register with a selected EPLMN among the EPLMNs appearing on the list.

9. The apparatus according to claim 8, wherein, by retaining the EPLMNs, the processing circuitry is configured to permit the apparatus, which operates in the manual network registration mode, to automatically join any of the PLMNs that the apparatus previously registered with since the most-recent manual registration operation.

10. The apparatus according to claim 8, wherein the processing circuitry is configured to reset the list in response to a new manual network registration attempt.

11. The apparatus according to claim 8, wherein the processing circuitry is configured to reset the list in response to a transition to an automatic network registration mode.

12. The apparatus according to claim 8, wherein the processing circuitry is configured to retain a definition of the PLMN as a manually registered PLMN, regardless of transitioning to any of the EPLMNs appearing on the list.

13. The apparatus according to claim 8, wherein the processing circuitry is configured to omit from the list one or more PLMNs that are defined as forbidden.

14. The apparatus according to claim 8, wherein the processing circuitry is configured to store the list so as to be directly accessible to a Radio Resource Control (RRC) layer of the apparatus, and to reselect a cell of the selected EPLMN using the RRC layer, by directly accessing the list using the RRC layer without involvement of a higher layer.

15. A mobile communication terminal comprising the apparatus of claim 8.

16. A chipset for processing signals in a mobile communication terminal, comprising the apparatus of claim 8.
